(19) United States
(12) Patent Application Publication
(10) Pub. No.: US 2016/0139401 A1
(43) Pub. Date: May 19, 2016

(54) GLASS PHOSPHOR COLOR WHEEL AND METHODS FOR PRODUCING THE SAME

(71) Applicant: TAIWAN COLOR OPTICS, INC., Taichung (TW)

(72) Inventors: Wood-Hi Cheng, Taichung (TW); Yung-Peng Chang, Taichung (TW); Chun-Chin Tsai, Taichung (TW); Yi-Chung Huang, Taichung (TW); Wei-Chih Cheng, Taichung (TW)

(21) Appl. No.: 14/542,400

(22) Filed: Nov. 14, 2014

(51) Int. Cl. G02B 26/00; G02B 1/02; C03C 27/00; C03B 19/06; C03B 33/06; G02B 1/11; C03B 19/09

(52) U.S. Cl. CPC G02B 26/008; G02B 1/11; G02B 1/02; C03B 19/09; C03B 19/06; C03B 33/06; C03C 27/00

(57) ABSTRACT

A glass phosphor color wheel includes a wheel body made of a glass phosphor formed by sintering a glass material and fluorescent powder. The fluorescent powder is a fluorescent material selected from the group consisting of yttrium aluminum garnet, nitride, silicate, aluminate, and oxynitride. The glass material is selected from the group consisting of a silicate system, a phosphor system, a borate system, and a tellurate system. A method for producing a glass phosphor color wheel includes concentrically placing an inner tube into an outer tube. The glass material and the fluorescent powder are placed between the outer and inner tubes and are formed into a wheel body. In another method, the glass material and the fluorescent powder are sintered at a temperature of 500-1000° C. to form at least one glass phosphor color block that is subsequently coupled to a substrate to form a glass phosphor color wheel.

### BACKGROUND OF THE INVENTION

1. Field of the Invention

The present invention relates to a glass phosphor color wheel and methods for producing the glass phosphor color wheel and, more particularly, to a color wheel formed by directly melting, sintering, or bonding a glass material with fluorescent powder.

2. Description of the Related Art

Current projectors generally include a digital micromirror device (DMD) and use a color wheel to separate and handle colors. The color wheel generally includes red, green, and blue filters as well as filters of other colors. When used in a projector of a DMD projecting system, the white light emitted by the power source of the projector is focused on the color wheel by a lens. The color wheel is driven by a high speed motor of the projector, splits the white light from the power source into colors, and projects the beams of colored lights onto a surface of the DMD. Then, the DMD projects the reflected beams out of the projector through the lens.

The color wheel of conventional projectors generally uses fluorescent gel produced after mixing a polymer gel (such as silica gel) and fluorescent powder. The polymer gel has poor thermal stability. The fluorescent gel deteriorates when the power of the exiting light source increases. For example, the silica gel can only withstand about 150° C. and about 2000 lumens. If the temperature is higher than 150° C., the silica gel will age and yellow, causing damage to the color wheel. Thus, the color wheel using silica gel cannot be used in optical systems operating at a high temperature or a high lumen.

Thus, a need exists for a novel color wheel and methods for producing the color wheel.

### SUMMARY OF THE INVENTION

An objective of the present invention is to provide a color wheel resistant to high temperature such that the color wheel can be used in an optical system of a projector operating at a high temperature or a high lumen, prolonging a service life of the color wheel.

The present invention fulfills the above objective by providing a glass phosphor color wheel including a wheel body made of a glass phosphor. The glass phosphor is formed by sintering a glass material and fluorescent powder. The fluorescent powder is a fluorescent material selected from the group consisting of yttrium aluminum garnet (YAG), nitride, silicate, aluminate, and oxynitride. The glass material is selected from the group consisting of a silicate system, a phosphor system, a borate system, and a tellurate system.

The glass phosphor color wheel can further include a substrate having a first face and a second face opposite to the first face. The substrate further includes a through-hole in a center thereof. The color wheel is coupled to the first face of the substrate.

The fluorescent powder can have a doping rate not larger than 50 wt %. The wheel body can include a primary color board and at least one mixing color board. Each of the primary color board and the at least one mixing color board is made of a glass phosphor formed by sintering a glass material and at least one different fluorescent powder. Fluorescent lights of different colors are adapted to be excited when light rays pass through the primary color board and the at least one mixing color board.

The at least one mixing color board can be fixed to the primary color board. The glass phosphor color wheel can further include a substrate having a first face and a second face opposite to the first face. The color wheel is coupled to the first face of the substrate.

In an embodiment, the primary color board and the at least one mixing color board are fixed to the first face of the substrate.

In an embodiment, the at least one color mixing board includes a plurality of color mixing boards spaced from each other, and the plurality of color mixing boards separates the primary color board into a plurality of color segments.

In another embodiment, the at least one color mixing board includes a plurality of color mixing boards adjacent to each other.

In an embodiment, the wheel body includes an incident face and a bottom face opposite to the incident face. The glass phosphor color wheel further includes a first coating and a second coating. The first coating is coupled to the incident face. The first coating has a thickness equal to an odd multiple of a quarter of a wavelength of a light adapted to be incident to the incident face. The first coating includes an anti-reflection coating. The second coating coupled to the bottom face.

In an embodiment, the first coating has a refractive index n, the glass phosphor color wheel has a refractive index nₛ, and air has a refractive index n₀, wherein n²=n₀*nₛ.

In an embodiment, the first coating further includes a narrow bandpass, and the second coating is a notch filter.

In another embodiment, the second coating is a highly reflective coating.

Each of the first coating and the second coating can be a single layer film, a dual-layer film, or a multilayer film.

In another aspect, a method for producing a glass phosphor color wheel includes:

(a) a mold producing step including concentrically placing an inner tube into an outer tube, with at least one receiving space defined between the outer tube and the inner tube;

(b) a material feeding step including placing a glass phosphor material into the at least receiving space, with the glass phosphor material including a glass material and fluorescent powder, wherein the fluorescent powder is a fluorescent material selected from the group consisting of yttrium aluminum garnet (YAG), nitride, silicate, aluminate, and oxynitride, and wherein the glass material is selected from the group consisting of a silicate system, a phosphor system, a borate system, and a tellurate system; and

(c) a formation step including forming the glass phosphor material in the at least one receiving space into a wheel body.

The formation step can include: (c1) a heating step including melting the glass material to envelope the fluorescent powder to form the glass phosphor, and fusing the glass material, the outer tube, and the inner tube together; and (c2) a cooling step including solidifying the glass phosphor.

The method can further include a cutting step (d) after the formation step (c). The cutting step (d) includes cutting the wheel body to form a plurality of color wheels.

The method can further include a polishing step (e) after the cutting step (d). The polishing step (e) includes polishing a face of each of the plurality of color wheels.

In a further aspect, a method for producing a glass phosphor color wheel includes:

(A) a sintering step including sintering a glass material and fluorescent powder at a temperature of 500-1000° C. to form at least one glass phosphor color block, wherein the fluorescent powder is a fluorescent material selected from the group consisting of yttrium aluminum garnet (YAG), nitride, silicate, aluminate, and oxynitride, and wherein the glass material is selected from the group consisting of a silicate system, a phosphor system, a borate system, and a tellurate system; and

(B) a formation step including coupling the at least one glass phosphor color block to a substrate to form a glass phosphor color wheel.

The advantages of the glass phosphor color wheel and the methods for producing the glass phosphor color wheel according to the present invention are that the glass phosphor color wheel resistant to high temperature can be used as the color wheel for projectors. Thus, the temperature-resistant color wheel according to the present invention can be used in optical systems operating at a high temperature or a high lumen while prolonging the service life of the color wheel.

The present invention will become clearer in light of the following detailed description of illustrative embodiments of this invention described in connection with the drawings.

### BRIEF DESCRIPTION OF THE DRAWINGS

FIG. 1 is a perspective view of a glass phosphor color wheel of an embodiment according to the present invention.

FIG. 2 is an exploded, perspective view of the glass phosphor color wheel of FIG. 1.

FIG. 3 is a cross sectional view of the glass phosphor color wheel of FIG. 1.

FIG. 4 is an exploded, perspective view of a glass phosphor color wheel of another embodiment according to the present invention.

FIG. 5 is a cross sectional view of the glass phosphor color wheel of FIG. 4.

FIG. 6 is a top view of a wheel body of an embodiment according to the present invention, with the wheel body including a primary color board and a plurality of mixing color boards adjacent to each other.

FIG. 7 is a top view of a wheel body of another embodiment according to the present invention, with the wheel body including a primary color board and a plurality of mixing color boards spaced from each other.

FIG. 8 is a diagrammatic view of a transmission-type color wheel according to the present invention, illustrating passage of a light through the color wheel coated with an anti-reflection coating.

FIG. 9 is a diagrammatic view of a reflective-type color wheel according to the present invention, illustrating passage of a light through the color wheel coated with an anti-reflection coating and a highly reflective coating.

FIG. 10 is an exploded, perspective view illustrating a mold producing step of a method for producing a glass phosphor color wheel according to the present invention, with an inner tube being placed into an outer tube.

FIG. 11 is a perspective view illustrating a material feeding step of the method according to the present invention, with materials for the glass phosphor color wheel being placed into a receiving space between the inner and outer tubes.

FIG. 12 is a perspective view illustrating a formation step of the method according to the present invention, with the materials for the glass phosphor color wheel being heated in the receiving space.

FIG. 13 is a perspective view illustrating a cutting step of the method according to the present invention for forming a plurality of color wheels.

FIG. 14 is a block diagram illustrating the method according to the present invention.

### DETAILED DESCRIPTION OF THE INVENTION

A glass phosphor color wheel and methods for producing the glass phosphor color wheel will now be set forth in connection with the accompanying drawings wherein like elements are designated by like reference numbers.

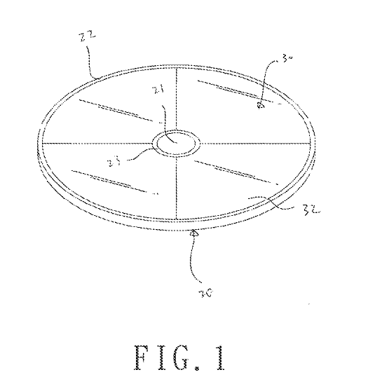

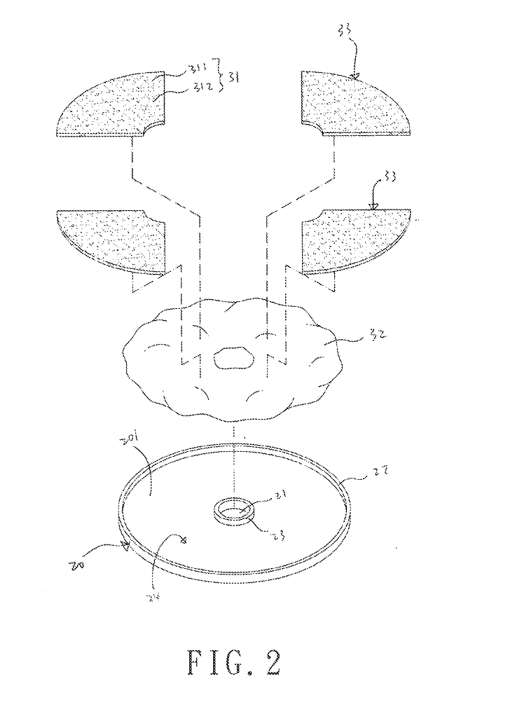

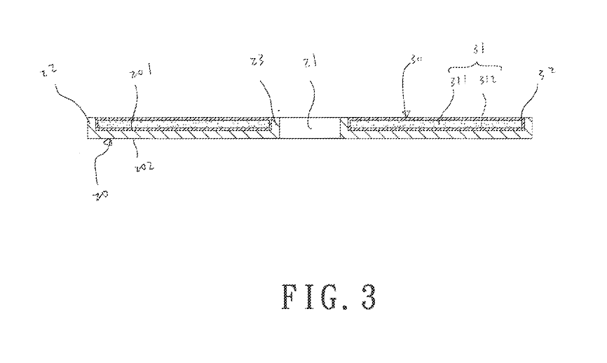

With reference to FIGS. 1-3, the glass phosphor color wheel according to the present invention includes a substrate 20 and a wheel body 30.

The substrate 20 is made of metal (such as stainless steel or aluminum) or ceramic material. The substrate 20 is a circular disc and includes a through-hole 21 in a center thereof. The substrate 20 includes a first face 201 and a second face 202 opposite to the first face 201. The through-hole 21 extends from the first face 201 through the second face 202. An outer wall 22 and an inner wall 23 are respectively formed on an outer peripheral edge and an inner peripheral edge of the first face 201, defining an annular groove 24 between the outer wall 22, the inner wall 23, and the substrate 20.

The wheel body 30 is made of a glass phosphor 31. The glass phosphor 31 is formed by sintering a glass material 311 and fluorescent powder 312. The glass material 311 is selected from the group consisting of a silicate system, a phosphor system, a borate system, and a tellurate system. The fluorescent powder 312 is a fluorescent material selected from the group consisting of yttrium aluminum garnet (YAG), nitride, silicate, aluminate, and oxynitride. Furthermore, the fluorescent powder 312 has a doping rate not larger than 50 wt %. The wheel body 30 is coupled to the first face 201 of the substrate 20. Specifically, the wheel body 30 can be embedded in the annular groove 24 by a colloid 32. The wheel body 30 includes at least one color block 33. In this embodiment, the wheel body 30 includes four color blocks 33. The size and color of each color block 33 can be the same or different according to needs.

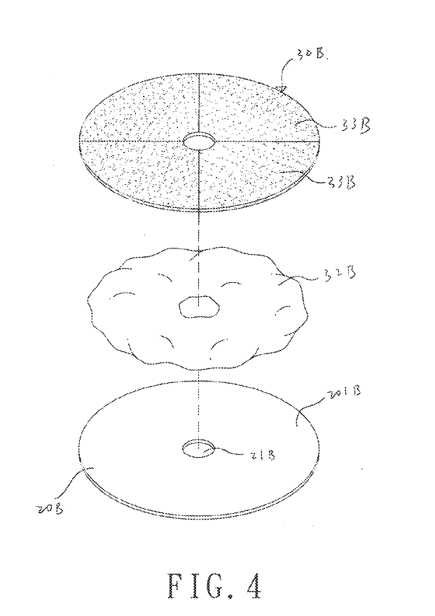

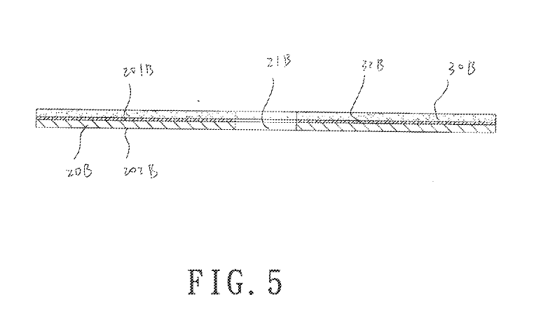

FIGS. 4 and 5 show another embodiment modified from the previous embodiment. Specifically, the glass phosphor color wheel includes a substrate 20B and a wheel body 30B. The substrate 20B is a circular disc and includes a through-hole 21B in a center thereof. The substrate 20B further includes a first face 201B and a second face 202B opposite to the first face 201B. The through-hole 21B extends from the first face 201B through the second face 202B. The wheel body 30B is coupled to the first face 201B of the substrate 20B. Specifically, the wheel body 30B is bonded to the first face 201B of the substrate 20B by a colloid 32B. The wheel body 30B includes at least one color block 33B. In this embodiment, the wheel body 30B is a complete, circular color block 33B.

With reference to FIGS. 1-3, a method for producing a glass phosphor color wheel according to the present invention includes:

(A) a sintering step including sintering a glass material 311 and fluorescent powder 312 at a temperature of 500-1000° C. to form at least one color block 33 of glass phosphor 31; and

(B) a formation step including coupling the at least one color block 33 to a substrate 20 to form a glass phosphor color wheel. The at least one color block 33 can be coupled to the substrate 20 through bonding or embedding by a colloid 32.

The glass phosphor 31 of the present invention is free of gel and is, thus, resistant to high temperature, avoiding the risk of deterioration. Thus, the color wheel made of glass phosphor can be used in high-power laser projector modules and can still possess inherent optical characteristics under high-power light sources. As a result, the color wheel can be used in optical systems operating at a high temperature or a high lumen while prolonging the service life of the color wheel.

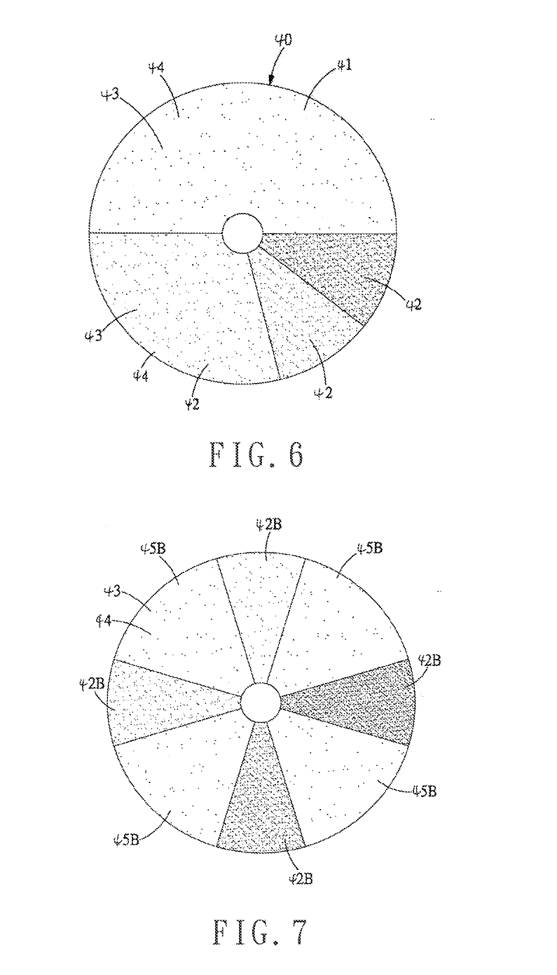

In an embodiment shown in FIG. 6, the wheel body 40 includes a primary color board 41 and at least one mixing color board 42. Each of the primary color board 41 and the at least one mixing color board 42 is made of a glass phosphor formed by sintering a glass material 43 and at least one different fluorescent powder 44. Fluorescent lights of different colors are adapted to be excited when light rays pass through the primary color board 41 and the at least one mixing color board 42. In this embodiment, the at least one color mixing board 42 includes a plurality of color mixing boards 42 adjacent to each other. Furthermore, the primary color board 41 occupies more than 50% of the overall area of the wheel body 40. Note that the areas of the color mixing boards 42 can be different from those shown in FIG. 6.

In another embodiment shown in FIG. 7, the primary color board 41B is a complete, circular disc. The at least one color mixing board 42B includes four color mixing boards 42B bonded to the primary color board 41B and spaced from each other. Thus, the color mixing boards 42B separates the primary color board 41B into a plurality of color segments 45B.

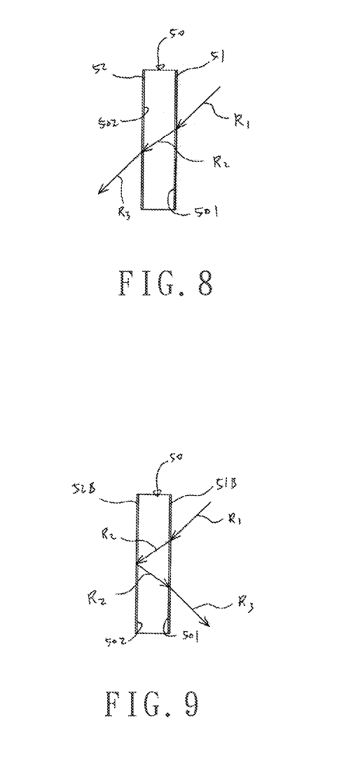

In order to increase the light input and the light output of the glass phosphor color wheel, an anti-reflection coating can directly or indirectly be disposed on the glass phosphor color wheel. In an embodiment shown in FIG. 8, the glass phosphor color wheel 50 is formed by directly melting, sintering, or bonding a glass material and fluorescent powder. The glass phosphor color wheel 50 includes an incident face 501 and a bottom face 502 opposite to the incident face 501.

A first coating 51 is coupled to the incident face 501 and has a thickness equal to an odd multiple of a quarter of a wavelength of a light adapted to be incident to the incident face 501. The first coating 51 includes an anti-reflection coating and a narrow bandpass. The first coating has a refractive index n, the glass phosphor color wheel has a refractive index nₛ, and air has a refractive index n₀, wherein n²=n₀*nₛ.

A second coating 52 is coupled to the bottom face 502. The second coating 52 is a notch filter.

The anti-reflection coating is directly or indirectly provided on the glass phosphor color wheel 50 to increase the light input and the light output of the glass phosphor color wheel 50. The anti-reflection coating can be formed on the glass phosphor color wheel by photonic crystals, nanoimprinting, semiconductor coating techniques, or laser microlithography. Each of the first coating 51 and the second coating 52 can be a single layer film, a dual-layer film, or a multilayer film. Thus, when the incident light R1 enters the glass phosphor color wheel 50, deflection and reflection of the light ray are avoided. Furthermore, when the light R2 in the glass phosphor color wheel 50 exits and becomes an emergent light R3, deflection and reflection of the light ray are also avoided. Thus, the light transmission percentage can be increased to be 98% of the incident light R1, effectively increasing the projector luminance.

In another embodiment shown in FIG. 9, the coating on the glass phosphor color wheel 50 is of reflective type. In this embodiment, the first coating 51B is an anti-reflection coating, and the second coating 52B is a highly reflective coating. Thus, when the incident light R1 enters the glass phosphor color wheel 50, deflection and reflection of the light ray are avoided. Furthermore, when the light R2 in the glass phosphor color wheel 50 is reflected by the second coating 52B, deflection of the light ray is reduced. When the light R2 transmits the glass phosphor color wheel 50 and becomes an emergent light R3, deflection and reflection of the light ray are also avoided. Thus, the optical effects can also be effectively increased.

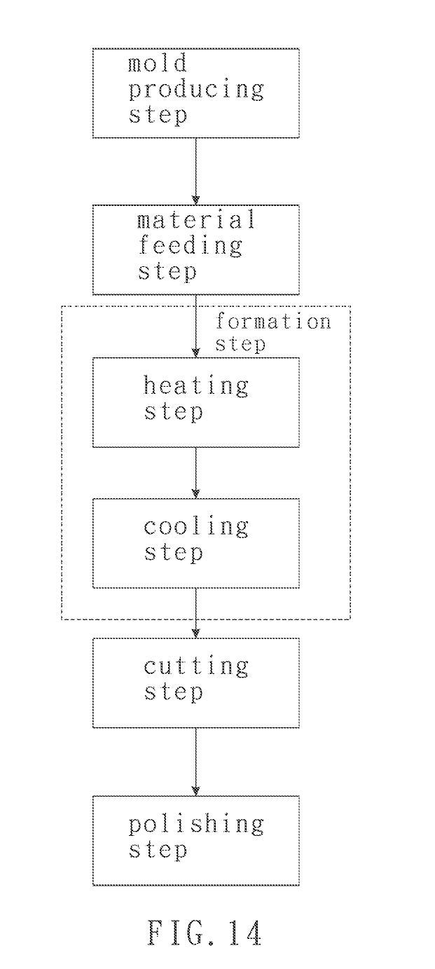

The present invention further includes a method for integrally producing a glass phosphor color wheel. With reference to FIG. 14, the method includes:

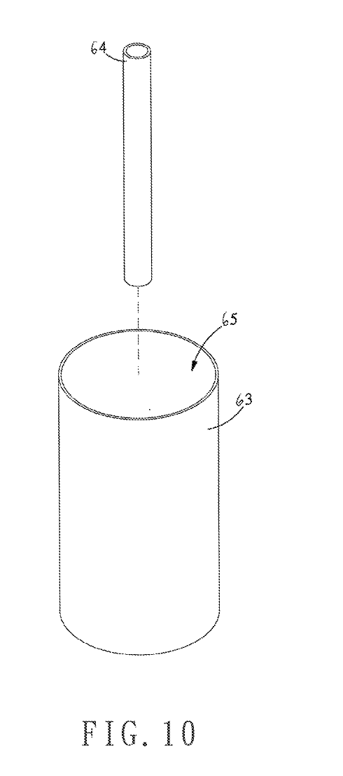

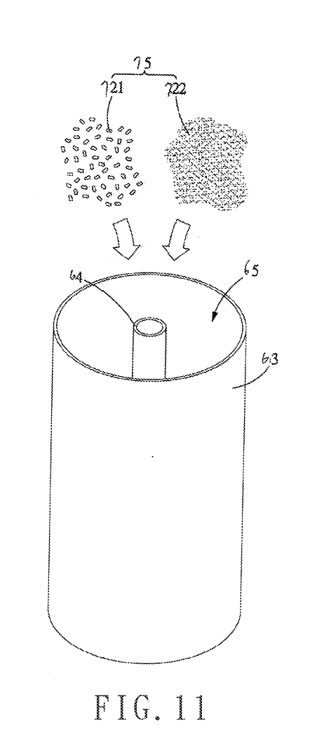

(a) a mold producing step: An inner tube 64 is placed into an outer tube 63, as shown in FIG. 10. The inner tube 64 and the outer tube 63 are concentric to each other. Each of the outer tube 63 and the inner tube 64 is cylindrical and made of aluminum oxide. At least one receiving space 65 is defined between the outer tube 63 and the inner tube 64.

(b) a material feeding step: A glass phosphor material 75 is placed into the at least one receiving space 65, as shown in FIG. 11. The glass phosphor material 75 includes a glass material 721 and fluorescent powder 722. The glass material 721 and the fluorescent powder 722 are uniformly distributed in the at least one receiving space 65. Preferably, the glass material 721 is glass particles for easy and even mixing with the fluorescent powder 722. Furthermore, the glass particles can easily be heated and melted in a subsequent heating step to increase the production efficiency.

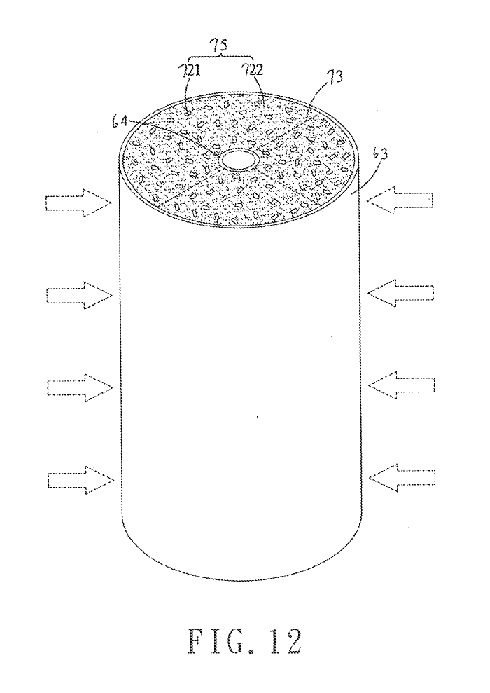

(c) a formation step: The glass phosphor material 75 in the at least one receiving space 65 is formed into a wheel body 70, as shown in FIGS. 11 and 12. In this embodiment, the formation step (c) includes a heating step (c 1) and a cooling step (c2). In the heating step (c1), the glass material 721 melts to envelope the fluorescent powder 722 to form the glass phosphor 72.

Furthermore, the glass material 721, the outer tube 63, and the inner tube 64 are fused together. Specifically, the glass material 721 is heated to a predetermined temperature and, thus, melt. However, the fluorescent powder 722 does not melt at the predetermined temperature. Thus, the glass material 721 directly melts and envelopes the fluorescent powder 722. Furthermore, the glass material 721, the outer tube 63, and the inner tube 64 are fused together. The melting point of the glass material 721 is generally about 650° C. The melting point of the fluorescent powder 722 is higher than 650° C. Thus, the predetermined temperature is higher than 650° C. but lower than the melting point of the fluorescent powder 722.

The cooling step (c2) includes solidifying the glass phosphor 72. Since the outer tube 63 and the inner tube 64 are made of aluminum oxide or even quartz, they can bond excellently with the glass material 721. Thus, the structural strength can be enhanced, and the outer and inner tubes 63 and 64 can be fused with the glass material 721. Production of the wheel body is, thus, accomplished.

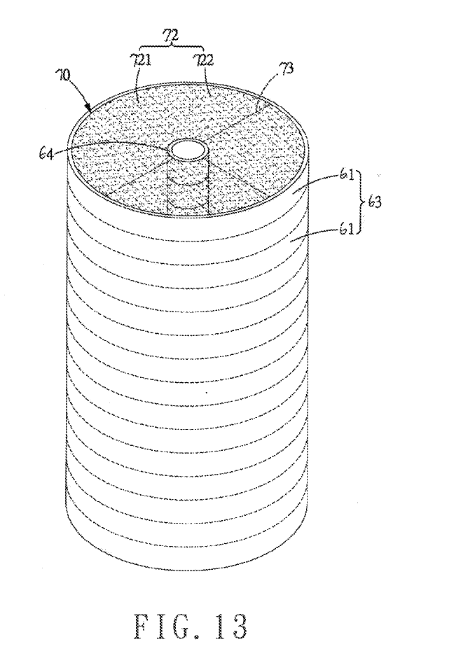

Furthermore, the method can further include a cutting step (d) after the formation step (c) by cutting along the phantom lines shown in FIG. 13 to obtain a plurality of color wheels of an appropriate size. However, the method does not have to include the cutting step (d) if the outer and inner tubes 63 and 64 of suitable thicknesses are used in the previous step.

Furthermore, the method can further include a polishing step (e) after the cutting step (d). The polishing step (e) includes polishing a face of each color wheel.

Although specific embodiments have been illustrated and described, numerous modifications and variations are still possible without departing from the scope of the invention. The scope of the invention is limited by the accompanying claims.

What is claimed is:

1. A glass phosphor color wheel comprising a wheel body made of a glass phosphor, with the glass phosphor formed by sintering a glass material and fluorescent powder, wherein the fluorescent powder is a fluorescent material selected from the group consisting of yttrium aluminum garnet (YAG), nitride, silicate, aluminate and oxynitride, and wherein the glass material is selected from the group consisting of a silicate system, a phosphor system, a borate system and a tellurate system.

2. The glass phosphor color wheel as claimed in claim 1, further comprising a substrate including a first face and a second face opposite to the first face, with the substrate further including a through-hole in a center thereof, and with the color wheel coupled to the first face of the substrate.

3. The glass phosphor color wheel as claimed in claim 1, wherein the fluorescent powder has a doping rate not larger than 50 wt %.

4. The glass phosphor color wheel as claimed in claim 1, with the wheel body including a primary color board and at least one mixing color board, with each of the primary color board and the at least one mixing color board made of a glass phosphor formed by sintering a glass material and at least one different fluorescent powder, and with fluorescent lights of different colors adapted to be excited when light rays pass through the primary color board and the at least one mixing color board.

5. The glass phosphor color wheel as claimed in claim 4, wherein the at least one mixing color board is fixed to the primary color board.

6. The glass phosphor color wheel as claimed in claim 4, further comprising a substrate including a first face and a second face opposite to the first face, with the color wheel coupled to the first face of the substrate.

7. The glass phosphor color wheel as claimed in claim 6, wherein the primary color board and the at least one mixing color board are fixed to the first face of the substrate.

8. The glass phosphor color wheel as claimed in claim 4, wherein the at least one color mixing board includes a plurality of color mixing boards spaced from each other, and wherein the plurality of color mixing boards separates the primary color board into a plurality of color segments.

9. The glass phosphor color wheel as claimed in claim 4, wherein the at least one color mixing board includes a plurality of color mixing boards adjacent to each other.

10. The glass phosphor color wheel as claimed in claim 1, with the wheel body including an incident face and a bottom face opposite to the incident face, with the glass phosphor color wheel further comprising a first coating and a second coating, with the first coating coupled to the incident face, with the first coating having a thickness equal to an odd multiple of a quarter of a wavelength of a light adapted to be incident to the incident face, with the first coating including an anti-reflection coating, and with the second coating coupled to the bottom face.

11. The glass phosphor color wheel as claimed in claim 10, wherein the first coating has a refractive index n, the glass phosphor color wheel has a refractive index nₛ, and air has a refractive index n₀, and wherein n²=n₀*nₛ.

12. The glass phosphor color wheel as claimed in claim 10, wherein the first coating further includes a narrow bandpass, and wherein the second coating is a notch filter.

13. The glass phosphor color wheel as claimed in claim 10, wherein the second coating is a highly reflective coating.

14. The glass phosphor color wheel as claimed in claim 10, wherein each of the first coating and the second coating is a single layer film, a dual-layer film, or a multilayer film.

15. A method for producing a glass phosphor color wheel, comprising:
(a) a mold producing step including concentrically placing an inner tube into an outer tube, with at least one receiving space defined between the outer tube and the inner tube;
(b) a material feeding step including placing a glass phosphor material into the at least receiving space, with the glass phosphor material including a glass material and fluorescent powder, wherein the fluorescent powder is a fluorescent material selected from the group consisting of yttrium aluminum garnet (YAG), nitride, silicate, aluminate and oxynitride, and wherein the glass material is selected from the group consisting of a silicate system, a phosphor system, a borate system and a tellurate system; and
(c) a formation step including forming the glass phosphor material in the at least one receiving space into a wheel body.

16. The method for producing the glass phosphor color wheel as claimed in claim 15, wherein the formation step includes: (c1) a heating step including melting the glass material to envelope the fluorescent powder to form the glass phosphor, and fusing the glass phosphor, the outer tube and the inner tube together; and (c2) a cooling step including solidifying the glass phosphor.

17. The method for producing the glass phosphor color wheel as claimed in claim 15, further comprising a cutting step (d) after the formation step (c), with the cutting step (d) including cutting the wheel body to form a plurality of color wheels.

18. The method for producing the glass phosphor color wheel as claimed in claim 17, further comprising a polishing step (e) after the cutting step (d), with the polishing step (e) including polishing a face of each of the plurality of color wheels.

19. A method for producing a glass phosphor color wheel, comprising:
(A) a sintering step including sintering a glass material and fluorescent powder at a temperature of 500-1000° C. to form at least one glass phosphor color block, wherein the fluorescent powder is a fluorescent material selected from the group consisting of yttrium aluminum garnet (YAG), nitride, silicate, aluminate and oxynitride, and wherein the glass material is selected from the group consisting of a silicate system, a phosphor system, a borate system and a tellurate system; and
(B) a formation step including coupling the at least one glass phosphor color block to a substrate to form a glass phosphor color wheel.
